(19) United States
(12) Patent Application Publication
(10) Pub. No.: US 2025/0248414 A1
(43) Pub. Date: Aug. 7, 2025

(54) NON-DAIRY CHEESE PRODUCT COMPRISING PLANT PROTEIN

(71) Applicant: Bunge SA, Geneva (CH)

(72) Inventors: Sherry Workman, Chesterfield, MO (US); Tammy Bratton, Chesterfield, MO (US); Swetha Salla, Naperville, IL (US)

(21) Appl. No.: 18/855,054

(22) PCT Filed: Apr. 6, 2023
(86) PCT No.: PCT/EP2023/059288

§ 371 Date: Oct. 8, 2024

Related U.S. Application Data
(60) Provisional application No. 63/362,718, filed on Apr. 8, 2022.
(60) Provisional application No. 63/479,615, filed on Jan. 12, 2023.

(51) Int. Cl. A23C 20/02; A23J 3/14

(52) U.S. Cl. CPC A23C 20/025; A23J 3/14

(57) ABSTRACT

The present disclosure is directed to a non-dairy vegan cheese product that comprises plant-based protein, having improved melt properties. Also disclosed are processes for preparing the vegan cheese product, uses of the vegan cheese product, and a food product comprising the vegan cheese product.

### CROSS-REFERENCE TO RELATED APPLICATIONS

This application claims the benefit of priority to U.S. Provisional Application Ser. No. 63/362,718 filed Apr. 8, 2022, and U.S. Provisional Application Ser. No. 63/479,615 filed Jan. 12, 2023, the contents of which are hereby expressly incorporated by reference in their entirety.

### FIELD OF THE INVENTION

The present disclosure is directed to plant-based cheese products. In particular, it provides non-dairy vegan cheese products that comprise plant-based protein and plant-based oil or fat, having improved functional and/or organoleptic properties. Also disclosed are processes for preparing the vegan cheese products, uses of the vegan cheese products, and food products comprising the vegan cheese products.

### BACKGROUND OF THE INVENTION

Current plant-based cheese products on the market have little to no protein content, causing them to have lower nutritional value as compared to conventional dairy-based cheese products. This has been noted by many as a huge gap in the industry on account of difficulty with formulating plant derived protein into cheese products. There are at least several drawbacks to the use of plant protein in vegan cheese products.

Firstly, it appears that the addition of plant protein poses a challenge in processing as well as functional and/or organoleptic properties of the manufactured cheese products. For example, adding plant protein to cheese products increases viscosity and may not provide as much gelling and/or setting functionality, which then may have a negative effect on organoleptic qualities of the cheese products. Secondly, when adding plant protein, other ingredients must be reduced and/or modified in the formulation which may result in an undesirable vegan cheese product (e.g., poor consistency, texture, firmness, etc.). Thirdly, adding plant protein can also often restrict melting as well leading to vegan cheese products that do not melt completely or at all. While there are vegan cheese products on the market that may have sufficient melting, most of them do not provide a similar texture and/or mouth feel experience as eating a dairy based cheese product. There are other marketed vegan cheese products that may also be hard and brittle, and fracture easily. Accordingly, it is generally accepted that the use of plant protein influences the organoleptic characteristics of the resultant vegan cheese products. Unfortunately, manufacturers of vegan cheese products thus far have mixed successes in extending one or more of the desirable sensorial attributes of dairy-based cheese using plant protein.

Previous attempts to overcome these problems have involved the use of pulse protein and/or enzyme for improving firmness of the high protein analog cheese. For instance, WO 2022/076349 discloses high protein analog cheese crosslinked with transglutaminase to increase the firmness or hardness of the analog cheese. WO 2021/080969 describes high protein analog cheese comprising native pea starch having firmness similar to dairy-based cheese. These attempts fail to teach how to improve other organoleptic properties, such as melting properties, of vegan cheese product. In particular, there is no disclosure of increasing the content level of faba bean protein and/or mung bean protein for delivering improving melting properties. Other attempts propose a gelled composition of mung bean protein and to a cheese-like food (EP2984936) and a plant-based cheese product comprising a plant-based protein, hydrophobic and modified starches, a fat component and an acidulant having similar melting characteristics to dairy-based cheese (WO2022/245524). However, these attempts do not disclose how to select suitable fat composition in order to improve melting behavior and/or appearance of the vegan cheese product.

It would thus be desirable to provide a non-dairy, vegan cheese product that comprises plant-based protein and that addresses the above-noted textural and melt issues associated with previously known vegan cheese products. There remains a need for an improved vegan cheese product by selecting the suitable plant-based protein and fat composition in order to obtain excellent organoleptic properties close to dairy based cheese product, particularly improved melt behavior.

### SUMMARY OF THE INVENTION

In one aspect, the present disclosure is directed to a vegan cheese product comprising (i) a plant-based protein, wherein at least 35 wt % of the plant-based protein is selected from the group consisting of faba bean protein, mung bean protein and combinations thereof, and wherein the wt % is relative to the total weight of the plant-based protein; (ii) a fat composition comprising (a) at most 9 wt % of total caprylic acid (C8:0) and capric acid (C10:0); and (b) from 20 wt % to 88 wt % of saturated fatty acids (SAFA); and wherein the fat composition has a weight ratio of total lauric acid (C12:0), myristic acid (C14:0) and palmitic acid (C16:0) to saturated fatty acid (SAFA) from 0.50:1 to 0.95:1; and wherein said wt % is relative to the acids bound as acyl groups in glycerides in the fat composition and based on the total weight of C8 to C24 fatty acids; and (iii) water.

In another aspect, the present disclosure is directed to a process for making the vegan cheese product as disclosed herein, the process comprising the steps of a) heating water to a temperature not exceeding 70° C.; b) adding plant-based protein to the water and mixing to hydrate the protein to provide a hydrated protein solution; c) pre-melting fat composition and adding the melted fat composition to the hydrated protein solution to provide a first mixture; d) mixing the first mixture to form an emulsion; e) adding the other ingredients to the emulsion to make a second mixture; f) homogenizing the second mixture; g) heating the second mixture to a temperature not exceeding 100° C.; and h) cooling the second mixture to form the vegan cheese product.

In yet another aspect, the present disclosure is directed to a vegan cheese product obtainable by the process for making the vegan cheese product as disclosed herein.

In a further aspect, the present disclosure is directed to a use of the vegan cheese product as disclosed herein in a food product.

In yet another aspect, the present disclosure is directed to a food product comprising the vegan cheese product as disclosed herein.

These and other features of the present disclosure will become apparent to one skilled in the art upon review of the following detailed description when taken in conjunction with the appended claims.

### BRIEF DESCRIPTION OF THE DRAWINGS

While the specification concludes with claims particularly pointing out and distinctly claiming the invention, it is believed that the invention will be better understood from the following description of the accompanying figures.

FIG. 1 provides four photographs (FIGS. 1A, 1B, 1C and 1D) depicting the Schreiber Melt Test results of the samples after treatment in the oven according to Example 1. FIG. 1A is a dairy based processed cheese slice, FIG. 1B is soy/canola protein blend, FIG. 1C is faba bean/canola protein blend, and FIG. 1D is pea/canola protein blend.

FIG. 2 provides four photographs (FIGS. 2A, 2B, 2C and 2D) depicting the test results of samples after the grilled cheese application test according to Example 1. FIG. 2A is a dairy based processed cheese slice, FIG. 2B is soy/canola protein blend, FIG. 2C is faba bean/canola protein blend, and FIG. 2D is pea/canola protein blend.

### DETAILED DESCRIPTION OF THE INVENTION

### Definitions

As used herein, articles such as “a” and “an” when used in a claim, are understood to mean one or more of what is claimed or described.

As used herein, the term “about” to modify a number is meant to include the number recited plus or minus 10%, preferably 5% or preferably 2%. Where legally permissible recitation of a value in a claim means about the value. Use of about in a claim or in the specification is not intended to limit the full scope of covered equivalents.

As used herein, the terms “include”, “includes” and “including” are meant to be non-limiting.

As used herein, the term “faba bean” includes broad bean, fava bean, faba bean, tic bean, tick bean and horse bean. The term “faba bean” is understood to include any beans derived from Vicia faba.

As used herein, the term “food product” means an edible product which are safe for consumption by people. Preferably, the “food product” is selected from the group consisting of a grain-based food product, a baked product, a health product, a nutrition product, a snack product, a liquid food, a semi-liquid food product, a flour and a spreadable food product. More preferably, the “food product” is a bakery product (e.g., pizza, tortilla, bread, sandwich, etc.) or a spreadable product.

As used herein, the term “mung bean” includes green gram, maash, mung, monggo or munggo. The term “mung bean” is understood to include any beans derived from Vigna radiata.

As used herein, the term “plant-based protein” means a protein originating from any non-dairy and non-animal based proteins. “Plant-based protein” encompass protein from any plant source. Suitable non-limiting examples of “plant-based protein” include protein derived from faba bean, mung bean, canola, rapeseed, soybean, pea, lentil, chickpea, and sunflower or mixtures thereof. The term “plant-based protein” may also encompass fungus-based proteins or proteins produced via fermentation by microbes, even though those proteins are not of plant origin.

As used herein, the term “vegan cheese product” means cheese analogues or cheese alternatives prepared with proteins of non-dairy or non-animal origin, preferably prepared with plant-based protein. In other words, the “vegan cheese product” is an edible cheese product which is entirely devoid of animal products, or animal derived products (e.g., casein and whey). The vegan cheese products of the present disclosure have an appearance, texture and/or melting characteristics similar to a dairy-based cheese.

It is understood that the methods that are disclosed in the Examples Section of the present application must be used to determine the respective values of the parameters of the inventions as described and claimed herein.

In all embodiments of the present disclosure, all percentages are by weight of the total composition, as evident by the context, unless specifically stated otherwise. All ratios are weight ratios, unless specifically stated otherwise, and all measurements are made at room temperature, such as 20° C. to 25° C., unless otherwise designated.

### Vegan Cheese Product

The present disclosure is directed to anon-dairy vegan cheese product that comprises plant-based protein, having improved organoleptic properties, including melt properties, and/or appearance as compared to previously known protein-containing vegan cheese products. Advantageously, the vegan cheese product of the present disclosure is more similar in behavior to dairy-based cheese than many previously known vegan cheese products. The resulting vegan cheese product advantageously may be firm enough to slice and shred, yet is still pliable, to deliver characteristics consistent with consumer expectations for dairy-based cheese.

As demonstrated in the Examples Section, the vegan cheese product of the present disclosure melts well, has improved melt properties, and/or provides a higher protein content than many other vegan cheeses. Essentially, the solution is to formulate the vegan cheese products using certain plant-based protein and fat composition according to the present disclosure. In fact, the inventors have discovered that the plant protein present in the vegan cheese products of the present disclosure acts as a binder and emulsifier. Without wishing to be bound to any particular theory, it is believed that inclusion of faba bean protein and/or mung bean protein results in an improved texture and sensory characteristic, as well as leading to a more authentic eating experience that mirrors that of dairy-based cheese.

Specifically, in one aspect, the present disclosure is directed to a vegan cheese product comprising (i) a plant-based protein, wherein at least 35 wt % of the plant-based protein is selected from the group consisting of faba bean protein, mung bean protein and combinations thereof, and wherein the wt % is relative to the total weight of the plant-based protein; (ii) a fat composition comprising (a) at most 9 wt % of total caprylic acid (C8:0) and capric acid (C10:0); and (b) from 20 wt % to 88 wt % of saturated fatty acids (SAFA); and wherein the fat composition has a weight ratio of total lauric acid (C12:0), myristic acid (C14:0) and palmitic acid (C16:0) to saturated fatty acid (SAFA) from 0.50:1 to 0.95:1; and wherein said wt % is relative to the acids bound as acyl groups in glycerides in the fat composition and based on the total weight of C8 to C24 fatty acids; and (iii) water.

The vegan cheese product as disclosed herein preferably comprises from 30 wt % to 80 wt % of the water, relative to the total weight of the product, more preferably from 40 wt % to 70 wt % and even more preferably from 50 wt % to 60 wt %.

### (i) Plant-Based Protein

The vegan cheese product as disclosed herein preferably comprises from 2 wt % to 20 wt % of the plant-based protein, relative to the total weight of the product, more preferably from 4 wt % to 20 wt % and even more preferably from 6 wt % to 20 wt %. Preferably, the plant-based protein is the only source of protein in the vegan cheese product, so that it contains no animal proteins, including for example, casein and whey.

In one approach, the plant-based protein in the vegan cheese product as disclosed herein preferably comprises at least 55 wt % of the plant-based protein selected from the group consisting of faba bean protein, mung bean protein and combinations thereof wherein the wt % is relative to the total weight of the plant-based protein, more preferably from 67 wt % to 100 wt %, and even more preferably from 68 wt % to 100 wt %. Preferably, the plant-based protein in the vegan cheese product as disclosed herein comprises faba bean protein.

The vegan cheese product according to the present disclosure may comprise other types of plant-based protein in addition to the faba bean protein and/or mung bean protein. In a preferred aspect, the vegan cheese product further comprises at most 45 wt %, relative to relative to the total weight of the plant-based protein, of one or more plant-based proteins other than faba bean protein and mung bean protein. With the described range of plant-based protein a mixture may use all proteins equally or use a majority of one protein compared to another. In some aspects the vegan cheese product described herein faba bean protein is the predominant protein used.

In another aspect, it is preferred that the plant-based protein does not contain any pea protein.

The amount of crude protein in a plant-based protein ingredient may depend on the form of the ingredient (e.g., whether the ingredient is in the form of an isolate, a concentrate, or a flour). More preferably, the plant-based protein in the vegan cheese product as disclosed herein comprises faba bean protein isolate. Even more preferably, the plant-based protein in the vegan cheese product as disclosed herein is faba bean protein isolate. As disclosed herein, it is further preferred that the faba bean protein isolate has a protein content of at least 80 wt % on dry matter, more preferably at least 85 wt % on dry matter and even more preferably from 88 wt % to 90 wt % on dry matter. Therefore, for purposes herein, the faba bean protein isolate refers to the crude protein content, i.e., the amount of protein contributed by the ingredient that delivers the plant-based protein. For instance, the faba bean protein isolate having 85 wt % on dry matter means that it includes about 85 wt % protein and 15 wt % non-protein components. It is also preferred that the faba bean protein isolate is in the form of a powder. Without wishing to be bound by theory, it has been found to be advantageous that the plant-based protein have a smaller particle size to allow for good dispersion of the protein within the fat composition.

Alternatively, in another aspect, the plant-based protein in the vegan cheese product as disclosed herein is preferably mung bean protein isolate. It is further preferred that the mung bean protein isolate has a protein content of at least 80 wt % on dry matter, more preferably at least 85 wt % on dry matter and even more preferably from 88 wt % to 90 wt % on dry matter.

### (ii) Fat Composition

The vegan cheese product further includes a fat composition. The term “fat” refers to glyceride fats and oils containing fatty acid acyl groups and does not imply any particular melting point. The term “oil” is used synonymously with “fat”. The fat composition according to the present disclosure may be made from naturally occurring or synthetic fats, fractions of naturally occurring or synthetic fats, or mixtures thereof, that satisfy the requirements defined herein. The fat composition according to the present disclosure may be subjected to any modification such as blending, interesterification, transesterification or fractionation. Preferably, the fat composition is, or is derived from, one or more plant-based fats including but not limited to coconut oil, palm kernel oil, palm oil, sunflower oil, canola oil, high oleic sunflower oil, soybean oil, rapeseed oil, a fraction thereof and mixtures thereof. In other examples, the fat component comprises one or more of coconut oil, coconut oil fraction, palm oil, palm oil fraction, palm kernel oil and palm kernel oil fraction. It is also preferred that the fat composition in the vegan cheese product as disclosed herein is, or is derived from non-hydrogenated fats. The term “non-hydrogenated” means that the fat composition is not prepared from a fat that has been subjected to hydrogenation to convert unsaturated fatty acyl groups to saturated fatty acyl groups.

The term “fatty acid” refers to straight chain saturated or unsaturated (including mono- and poly unsaturated) carboxylic acids having from 8 to 24 carbon atoms. A fatty acid having x carbon atoms and y double bonds may be denoted Cx:y. For example, palmitic acid may be denoted C16:0 and oleic acid may be denoted C18:1. The fatty acid profile may be determined by fatty acid methyl ester analysis (FAME) using gas chromatography according to ISO 12966-2:2014 and ISO 1296-4:2015. Thus, percentages of fatty acids in fat compositions (e.g., lauric acid (C12:0), myristic acid acid (C14:0), palmitic acid (C16:0) etc.) referred to herein, unless otherwise stated, include acyl groups such as tri-, di- and mono-glycerides are based on the total weight of C8 to C24 fatty acid residues.

The vegan cheese product as disclosed herein preferably comprises from 10 wt % to 35 wt % of the fat composition, relative to the total weight of the product, more preferably from 15 wt % to 30 wt % and even more preferably from 20 wt % to 25 wt %.

In a preferred aspect, the vegan cheese product as disclosed herein comprises (i) from 2 wt % to 20 wt % of a plant-based protein relative to the total weight of the product, wherein at least 55 wt % of the plant-based protein relative to the total weight of the plant-based protein is selected from the group consisting of faba bean protein, mung bean protein and combinations thereof; (ii) from 10 wt % to 35 wt % of a fat composition relative to the total weight of the product, comprising (a) at most 9 wt % of total caprylic acid (C8:0) and capric acid (C10:0); and (b) from 20 wt % to 88 wt % % of saturated fatty acids (SAFA); and wherein the fat composition has a weight ratio of total lauric acid (C12:0), myristic acid (C14:0) and palmitic acid (C16:0) to saturated fatty acid (SAFA) from 0.50:1 to 0.95:1; and wherein said wt % is relative to the acids bound as acyl groups in glycerides in the fat composition and based on the total weight of C8 to C24 fatty acids; and (iii) from 30 wt % to 80 wt % of water relative to the total weight of the product.

In a more preferred aspect, the vegan cheese product as disclosed herein comprises (i) from 4 wt % to 20 wt % of a plant-based protein relative to the total weight of the product, wherein from 67 wt % to 100 wt % of the plant-based protein relative to the total weight of the plant-based protein is selected from the group consisting of faba bean protein, mung bean protein and combinations thereof; (ii) from 15 wt % to 30 wt % of a fat composition relative to the total weight of the product, comprising (a) at most 9 wt % of total caprylic acid (C8:0) and capric acid (C10:0); and (b) from 20 wt % to 88 wt % of saturated fatty acids (SAFA); and wherein the fat composition has a weight ratio of total lauric acid (C12:0), myristic acid (C14:0) and palmitic acid (C16:0) to saturated fatty acid (SAFA) from 0.50:1 to 0.95:1; and wherein said wt % is relative to the acids bound as acyl groups in glycerides in the fat composition and based on the total weight of C8 to C24 fatty acids; and (iii) from 40 wt % to 70 wt % of water relative to the total weight of the product.

In an even more preferred aspect, the vegan cheese product as disclosed herein comprises (i) from 6 wt % to 20 wt % of a plant-based protein relative to the total weight of the product, wherein from 68 wt % to 100 wt % of the plant-based protein relative to the total weight of the plant-based protein is selected from the group consisting of faba bean protein, mung bean protein and combinations thereof; (ii) from 20 wt % to 25 wt % of a fat composition relative to the total weight of the product, comprising (a) at most 9 wt % of total caprylic acid (C8:0) and capric acid (C10:0); and (b) from 20 wt % to 88 wt % of saturated fatty acids (SAFA); and wherein the fat composition has a weight ratio of total lauric acid (C12:0), myristic acid (C14:0) and palmitic acid (C16:0) to saturated fatty acid (SAFA) from 0.50:1 to 0.95:1; and wherein said wt % is relative to the acids bound as acyl groups in glycerides in the fat composition and based on the total weight of C8 to C24 fatty acids; and (iii) from 50 wt % to 60 wt % of water relative to the total weight of the product.

The fat composition in the vegan cheese product as disclosed herein preferably comprises at most 8.5 wt % of total caprylic acid (C8:0) and capric acid (C10:0) and more preferably from 0.1 wt % to 8 wt %; wherein said wt % is relative to the acids bound as acyl groups in glycerides in the fat composition and based on the total weight of C8 to C24 fatty acids.

The fat composition in the vegan cheese product as disclosed herein preferably comprises from 3 wt % to 60 wt % of lauric acid (C12:0) and more preferably from 4 wt % to 55 wt %; wherein said wt % is relative to the acids bound as acyl groups in glycerides in the fat composition and based on the total weight of C8 to C24 fatty acids.

The fat composition in the vegan cheese product as disclosed herein preferably comprises from 1 wt % to 25 wt % of myristic acid (C14:0) and more preferably from 2 wt % to 22 wt %; wherein said wt % is relative to the acids bound as acyl groups in glycerides in the fat composition and based on the total weight of C8 to C24 fatty acids.

The fat composition in the vegan cheese product as disclosed herein preferably comprises from 5 wt % to 45 wt % of palmitic acid (C16:0) and more preferably from 7 wt % to 40 wt %; wherein said wt % is relative to the acids bound as acyl groups in glycerides in the fat composition and based on the total weight of C8 to C24 fatty acids.

The fat composition in the vegan cheese product as disclosed herein preferably comprises from 1 wt % to 15 wt % of stearic acid (C18:0) and more preferably from 1.5 wt % to 10.0 wt %; wherein said wt % is relative to the acids bound as acyl groups in glycerides in the fat composition and based on the total weight of C8 to C24 fatty acids.

The fat composition in the vegan cheese product as disclosed herein preferably comprises from 9 wt % to 45 wt % of oleic acid (C18:1) and more preferably from 10 wt % to 40 wt % by weight; wherein said wt % is relative to the acids bound as acyl groups in glycerides in the fat composition and based on the total weight of C8 to C24 fatty acids.

The fat composition in the vegan cheese product as disclosed herein preferably comprises from 0.5 wt % to 15 wt % of linoleic acid (C18:2) and more preferably from 1 wt % to 10 wt %; wherein said wt % is relative to the acids bound as acyl groups in glycerides in the fat composition and based on the total weight of C8 to C24 fatty acids.

The fat composition in the vegan cheese product as disclosed herein preferably comprises from 10 wt % to 50 wt % of monounsaturated fatty acids (MUFA) and more preferably from 10 wt % to 40 wt %; wherein said wt % is relative to the acids bound as acyl groups in glycerides in the fat composition and based on the total weight of C8 to C24 fatty acids.

The fat composition in the vegan cheese product as disclosed herein preferably comprises at most 15 wt % of polyunsaturated fatty acids (PUFA) and more preferably from 1 wt % to 12 wt %; wherein said wt % is relative to the acids bound as acyl groups in glycerides in the fat composition and based on the total weight of C8 to C24 fatty acids.

The fat composition in the vegan cheese product as disclosed herein preferably comprises from 30 wt % to 88 wt % of the saturated fatty acids (SAFA), preferably from 40 wt % to 88 wt %; wherein said wt % is relative to the acids bound as acyl groups in glycerides in the fat composition and based on the total weight of C8 to C24 fatty acids.

The fat composition in the vegan cheese product as disclosed herein preferably has a weight ratio of total lauric acid (C12:0), myristic acid (C14:0) and palmitic acid (C16:0) to saturated fatty acid (SAFA) from 0.70:1 to 0.95:1, more preferably from 0.75:1 to 0.93:1 and even more preferably from 0.80:1 to 0.92:1.

In a preferred aspect, the vegan cheese product as disclosed herein comprises (i) from 2 wt % to 20 wt % of a plant-based protein relative to the total weight of the product, wherein at least 55 wt % of the plant-based protein relative to the total weight of the plant-based protein is selected from the group consisting of faba bean protein, mung bean protein and combinations thereof; (ii) from 10 wt % to 35 wt % of a fat composition relative to the total weight of the product, comprising (a) at most 8.5 wt % of total caprylic acid (C8:0) and capric acid (C10:0); (b) from 30 wt % to 88 wt % of saturated fatty acids (SAFA); (c) from 3 wt % to 60 wt % of lauric acid (C12:0); (d) from 1 wt % to 25 wt % of myristic acid (C14:0); (e) from 5 wt % to 45 wt % of palmitic acid (C16:0); (f) from 1 wt % to 15 wt % of stearic acid (C18:0); (g) from 9 wt % to 45 wt % of oleic acid (C18:1); (h) from 0.5 wt % to 15 wt % of linoleic acid (C18:2); and (i) from 10 wt % to 50 wt % of monounsaturated fatty acids (MUFA); and and wherein the fat composition has a weight ratio of total lauric acid (C12:0), myristic acid (C14:0) and palmitic acid (C16:0) to saturated fatty acid (SAFA) from 0.70:1 to 0.95:1; and wherein said wt % is relative to the acids bound as acyl groups in glycerides in the fat composition and based on the total weight of C8 to C24 fatty acids; and (iii) from 30 wt % to 80 wt % of water relative to the total weight of the product.

In a more preferred aspect, the vegan cheese product as disclosed herein comprises (i) from 4 wt % to 20 wt % of a plant-based protein relative to the total weight of the product, wherein from 67 wt % to 100 wt % of the plant-based protein relative to the total weight of the plant-based protein is selected from the group consisting of faba bean protein, mung bean protein and combinations thereof; (ii) from 15 wt % to 30 wt % of a fat composition relative to the total weight of the product, comprising (a) from 0.1 wt % to 8 wt % of total caprylic acid (C8:0) and capric acid (C10:0); (b) from 40 wt % to 88 wt % of saturated fatty acids (SAFA); (c) from 4 wt % to 55 wt % of lauric acid (C12:0); (d) from 2 wt % to 22 wt % of myristic acid (C14:0); (e) from 7 wt % to 40 wt % of palmitic acid (C16:0); (f) from 1.5 wt % to 10.0 wt % of stearic acid (C18:0); (g) from 10 wt % to 40 wt % of oleic acid (C18:1); (h) from 1 wt % to 10 wt % of linoleic acid (C18:2); and (i) from 10 wt % to 40 wt % of monounsaturated fatty acids (MUFA); and wherein the fat composition has a weight ratio of total lauric acid (C12:0), myristic acid (C14:0) and palmitic acid (C16:0) to saturated fatty acid (SAFA) from 0.75:1 to 0.93:1; and wherein said wt % is relative to the acids bound as acyl groups in glycerides in the fat composition and based on the total weight of C8 to C24 fatty acids; and (iii) from 40 wt % to 70 wt % of water relative to the total weight of the product.

In an even more preferred aspect, the vegan cheese product as disclosed herein comprises (i) from 6 wt % to 20 wt % of a plant-based protein relative to the total weight of the product, wherein from 68 wt % to 100 wt % of the plant-based protein relative to the total weight of the plant-based protein is selected from the group consisting of faba bean protein, mung bean protein and combinations thereof; (ii) from 20 wt % to 25 wt % of a fat composition relative to the total weight of the product, comprising (a) from 0.1 wt % to 8 wt % of total caprylic acid (C8:0) and capric acid (C10:0); (b) from 40 wt % to 88 wt % of saturated fatty acids (SAFA); (c) from 4 wt % to 55 wt % of lauric acid (C12:0); (d) from 2 wt % to 22 wt % of myristic acid (C14:0); (e) from 7 wt % to 40 wt % of palmitic acid (C16:0); (f) from 1.5 wt % to 10.0 wt % of stearic acid (C18:0); (g) from 10 wt % to 40 wt % of oleic acid (C18:1); (h) from 1 wt % to 10 wt % of linoleic acid (C18:2); (i) from 10 wt % to 40 wt % of monounsaturated fatty acids (MUFA); and (j) at most 15 wt % of polyunsaturated fatty acids (PUFA); and wherein the fat composition has a weight ratio of total lauric acid (C12:0), myristic acid (C14:0) and palmitic acid (C16:0) to saturated fatty acid (SAFA) from 0.80:1 to 0.92:1; and wherein said wt % is relative to the acids bound as acyl groups in glycerides in the fat composition and based on the total weight of C8 to C24 fatty acids; and (iii) from 50 wt % to 60 wt % of water relative to the total weight of the product.

In a most preferred aspect, the vegan cheese product as disclosed herein comprises (i) from 6 wt % to 20 wt % of a plant-based protein relative to the total weight of the product, wherein from 69 wt % to 100 wt % of the plant-based protein relative to the total weight of the plant-based protein is selected from the group consisting of faba bean protein isolate, mung bean protein isolate and combinations thereof; (ii) from 21 wt % to 24 wt % of a fat composition relative to the total weight of the product, comprising (a) from 0.1 wt % to 7.8 wt % of total caprylic acid (C8:0) and capric acid (C10:0); (b) from 45 wt % to 88 wt of saturated fatty acids (SAFA); (c) from 4 wt % to 55 wt % of lauric acid (C12:0); (d) from 2 wt % to 22 wt % of myristic acid (C14:0); (e) from 7 wt % to 40 wt % of palmitic acid (C16:0); (f) from 1.5 wt % to 7.0 wt % of stearic acid (C18:0); (g) from 10 wt % to 40 wt % of oleic acid (C18:1); (h) from 1 wt % to 10 wt % of linoleic acid (C18:2); (i) from 10 wt % to 40 wt % of monounsaturated fatty acids (MUFA); and (j) from 1 wt % to 12 wt % of polyunsaturated fatty acids (PUFA) and wherein the fat composition has a weight ratio of total lauric acid (C12:0), myristic acid (C14:0) and palmitic acid (C16:0) to saturated fatty acid (SAFA) from 0.80:1 to 0.92:1; and wherein said wt % is relative to the acids bound as acyl groups in glycerides in the fat composition and based on the total weight of C8 to C24 fatty acids; and (iii) from 50 wt % to 57 wt % of water relative to the total weight of the product.

The solid fat contents of the fat composition in the vegan cheese product as disclosed herein may be measured on unstabilized fat according to ISO 8292-1:2008. The fat composition in the vegan cheese product as disclosed herein preferably has from 35 to 85 solid fat content at 10° C. and more preferably from 40 to 80; wherein the solid fat content is measured on unstabilized fat according to ISO 8292-1:2008. The fat composition in the vegan cheese product as disclosed herein preferably has from 5 to 75 solid fat content at 20° C. and more preferably from 8 to 70; wherein the solid fat content is measured on unstabilized fat according to ISO 8292-1:2008. The fat composition in the vegan cheese product as disclosed herein preferably has at most 55 solid fat content at 25° C. and more preferably from 0 to 50; wherein the solid fat content is measured on unstabilized fat according to ISO 8292-1:2008. The fat composition in the vegan cheese product as disclosed herein preferably has at most 20 solid fat content at 30° C. and more preferably from 0 to 15; wherein the solid fat content is measured on unstabilized fat according to ISO 8292-1:2008. The fat composition in the vegan cheese product as disclosed herein preferably has at most solid fat content at 35° C. and more preferably from 0 to 10; wherein the solid fat content is measured on unstabilized fat according to ISO 8292-1:2008.

In a preferred aspect, the fat composition in the vegan cheese product as disclosed herein has from 35 to 85 solid fat content at 10° C.; from 5 to 75 solid fat content at 20° C.; at most 55 solid fat content at 25° C.; at most 20 solid fat content at 30° C. and at most 15 solid fat content at 35° C. In a more preferred aspect, the fat composition in the vegan cheese product as disclosed herein has from 40 to 80 solid fat content at 10° C.; from 8 to 70 solid fat content at 20° C.; from 0 to 50 solid fat content at 25° C.; from 0 to 15 solid fat content at 30° C. and from 0 to 10 solid fat content at 35° C.

Without wishing to be bound by theory, it is believed that when the fat component has a solid fat content within the specified ranges as described herein, the fat component may act even more similarly to butter fat, which may further contribute to the vegan cheese product having a texture and melt profile similar to a dairy-based cheese.

(iii) Other Ingredients

The vegan cheese product as disclosed herein preferably further comprises (iv) at most 25 wt % of starch and hydrocolloid wherein wt % is relative to the total weight of the vegan cheese product, more preferably from 10 wt % to 20 wt % and even more preferably from 12 wt % to 18 wt %. Examples of suitable starches and hydrocolloids include, but are not limited to, potato starch, corn starch, tapioca flour, saga starch, potato starch, and combinations thereof. Suitable starches and hydrocolloids for use in the vegan cheese products of the present disclosure include Ticagel® CA 0979M (available from Ingredion Incorporated). Starch may also be modified to improve process tolerance such as by etherification or esterification or thermal inhibition. Examples of modified starch further include phosphate crosslinked starch, adipate crosslinked starch, hydroxypropylated starch, acetylated starch, starch citrates, and succinate modified starch including octenylsuccinate (OSA) modified starches.

Hydrocolloids as used herein refers to texturizing agents useful in the vegan cheese products of the present disclosure. Hydrocolloids include gums and fibers including but not limited to xanthan gum, guar gum, acacia gum, locust bean gum, carrageenan, pectin, agar, modified celluloses such as carboxymethylcellulose (CMC) or HPMC, and mixtures thereof. The vegan cheese product as disclosed herein also preferably further comprises (v) one or more ingredients selected from the group consisting of flavor, colorant, salt, lactic acid, and sorbic acid.

The vegan cheese product as disclosed herein is preferably free or substantially free or essentially free of a protease enzyme. More preferably, the vegan cheese product as disclosed herein is free of transglutaminase or bromelain. The term “substantially free” or “essentially free” as used herein, unless otherwise specified, refers less than 0.5 wt % or even less than 0.1 wt %, relative to the weight of the vegan cheese product, of the stated protease enzyme.

It will be appreciated that the vegan cheese product according to the present disclosure have acceptable meltability at cooking temperatures, firm texture at refrigeration temperature, and/or suitable overall mouthfeel similar to dairy-based cheese products. As such, the vegan cheese product as disclosed herein preferably has a melt test distance of at least 3 mm, more preferably at least 6 mm and even more preferably from 9 mm to 18 mm, from center to melt edge according to the Schreiber Melt Test as described in Example 1. The vegan cheese product may be provided in a variety of flavors, such as American, Swiss, gouda, provolone, cheddar, Colby, Colby-jack, pepper-jack or mozzarella. Flavoring agents may be added to achieve the desired flavor profile. Colors may also be added to achieve the desired color to the vegan cheese product.

In one preferred aspect, the vegan cheese product as disclosed herein comprises (i) from 10 wt % to 20 wt % of a plant-based protein relative to the total weight of the product, wherein from 55 wt % to 75 wt % of the plant-based protein relative to the total weight of the plant-based protein is selected from the group consisting of faba bean protein, mung bean protein and combinations thereof; (ii) from 10 wt % to 35 wt % of a fat composition relative to the total weight of the product, comprising (a) at most 2.0 wt % of total caprylic acid (C8:0) and capric acid (C10:0); and (b) from 30 wt % to 60 wt % of saturated fatty acids (SAFA); and wherein the fat composition has a weight ratio of total lauric acid (C12:0), myristic acid (C14:0) and palmitic acid (C16:0) to saturated fatty acid (SAFA) from 0.75:1 to 0.95:1; and wherein said wt % is relative to the acids bound as acyl groups in glycerides in the fat composition and based on the total weight of C8 to C24 fatty acids; and (iii) from 30 wt % to 80 wt % of water relative to the total weight of the product.

In one more preferred aspect, the vegan cheese product as disclosed herein comprises (i) from 13 wt % to 20 wt % of a plant-based protein relative to the total weight of the product, wherein from 67 wt % to 72 wt % of the plant-based protein relative to the total weight of the plant-based protein is selected from the group consisting of faba bean protein, mung bean protein and combinations thereof; (ii) from 15 wt % to 30 wt % of a fat composition relative to the total weight of the product, comprising (a) at most 1.0 wt % of total caprylic acid (C8:0) and capric acid (C10:0); and (b) from 40 wt % to 55 wt % of saturated fatty acids (SAFA); and wherein the fat composition has a weight ratio of total lauric acid (C12:0), myristic acid (C14:0) and palmitic acid (C16:0) to saturated fatty acid (SAFA) from 0.80:1 to 0.95:1; and wherein said wt % is relative to the acids bound as acyl groups in glycerides in the fat composition and based on the total weight of C8 to C24 fatty acids; (iii) from 40 wt % to 70 wt % of water relative to the total weight of the product; and (iv) at most 10 wt % of starch and hydrocolloid relative to the total weight of the product.

In one even more preferred aspect, the vegan cheese product as disclosed herein comprises (i) from 15 wt % to 20 wt % of a plant-based protein relative to the total weight of the product, wherein from 68 wt % to 71 wt % of the plant-based protein relative to the total weight of the plant-based protein is selected from the group consisting of faba bean protein isolate, mung bean protein isolate and combinations thereof; (ii) from 20 wt % to 25 wt % of a fat composition relative to the total weight of the product, comprising (a) at most 0.5 wt % of total caprylic acid (C8:0) and capric acid (C10:0); and (b) from 45 wt % to 55 wt % of saturated fatty acids (SAFA); and wherein the fat composition has a weight ratio of total lauric acid (C12:0), myristic acid (C14:0) and palmitic acid (C16:0) to saturated fatty acid (SAFA) from 0.85:1 to 0.95:1; and wherein said wt % is relative to the acids bound as acyl groups in glycerides in the fat composition and based on the total weight of C8 to C24 fatty acids; (iii) from 50 wt % to 60 wt % of water relative to the total weight of the product; and (iv) at most 3 wt % of starch and hydrocolloid relative to the total weight of the product.

In one most preferred aspect, the vegan cheese product as disclosed herein comprises (i) from 15 wt % to 20 wt % of a plant-based protein relative to the total weight of the product, wherein from 69 wt % to 70 wt % of the plant-based protein relative to the total weight of the plant-based protein is selected from the group consisting of faba bean protein isolate and wherein the weight ratio of faba bean protein isolate to canola isolate is from 2:1 to 3:1; (ii) from 20 wt % to 25 wt % of a fat composition relative to the total weight of the product, comprising (a) at most 0.5 wt % of total caprylic acid (C8:0) and capric acid (C10:0); (b) from 45 wt % to 55 wt % of saturated fatty acids (SAFA); (c) at most 6 wt % of lauric acid (C12:0); (d) at most 5 wt % of myristic acid (C14:0); (e) from 30 wt % to 45 wt % of palmitic acid (C16:0); (f) from 1.5 wt % to 5.0 wt % of stearic acid (C18:0); (g) from 35 wt % to 45 wt % of oleic acid (C18:1); (h) from 1 wt % to 5 wt % of linoleic acid (C18:2); and (i) from 30 wt % to 50 wt % of monounsaturated fatty acids (MUFA); and wherein the fat composition has a weight ratio of total lauric acid (C12:0), myristic acid (C14:0) and palmitic acid (C16:0) to saturated fatty acid (SAFA) from 0.87:1 to 0.93:1; and wherein said wt % is relative to the acids bound as acyl groups in glycerides in the fat composition and based on the total weight of C8 to C24 fatty acids; (iii) from 50 wt % to 60 wt % of water relative to the total weight of the product; and (iv) at most 1 wt % of starch and hydrocolloid relative to the total weight of the product.

In another preferred aspect, the vegan cheese product as disclosed herein comprises (i) from 2 wt % to 15 wt % of a plant-based protein relative to the total weight of the product, wherein from 72 wt % to 100 wt % of the plant-based protein relative to the total weight of the plant-based protein is selected from the group consisting of faba bean protein, mung bean protein and combinations thereof; (ii) from 10 wt % to 35 wt % of a fat composition relative to the total weight of the product, comprising (a) from 1.0 wt % to 8.5 wt % of total caprylic acid (C8:0) and capric acid (C10:0); and (b) from 45 wt % to 75 wt % of saturated fatty acids (SAFA); and wherein the fat composition has a weight ratio of total lauric acid (C12:0), myristic acid (C14:0) and palmitic acid (C16:0) to saturated fatty acid (SAFA) from 0.75:1 to 0.95:1; and wherein said wt % is relative to the acids bound as acyl groups in glycerides in the fat composition and based on the total weight of C8 to C24 fatty acids; and (iii) from 30 wt % to 80 wt % of water relative to the total weight of the product.

In another more preferred aspect, the vegan cheese product as disclosed herein comprises (i) from 4 wt % to 10 wt % of a plant-based protein relative to the total weight of the product, wherein from 80 wt % to 100 wt % of the plant-based protein relative to the total weight of the plant-based protein is selected from the group consisting of faba bean protein, mung bean protein and combinations thereof; (ii) from 15 wt % to 30 wt % of a fat composition relative to the total weight of the product, comprising (a) from 3.0 wt % to 8.0 wt % of total caprylic acid (C8:0) and capric acid (C10:0); and (b) from 50 wt % to 70 wt % of saturated fatty acids (SAFA); and wherein the fat composition has a weight ratio of total lauric acid (C12:0), myristic acid (C14:0) and palmitic acid (C16:0) to saturated fatty acid (SAFA) from 0.80:1 to 0.95:1; and wherein said wt % is relative to the acids bound as acyl groups in glycerides in the fat composition and based on the total weight of C8 to C24 fatty acids; (iii) from 40 wt % to 70 wt % of water relative to the total weight of the product; and (iv) from 10 wt % to 20 wt % of starch and hydrocolloid relative to the total weight of the product.

In another even more preferred aspect, the vegan cheese product as disclosed herein comprises (i) from 5 wt % to 9 wt % of a plant-based protein relative to the total weight of the product, wherein from 85 wt % to 100 wt % of the plant-based protein relative to the total weight of the plant-based protein is selected from the group consisting of faba bean protein isolate, mung bean protein isolate and combinations thereof; (ii) from 20 wt % to 25 wt % of a fat composition relative to the total weight of the product, comprising (a) from 5.0 wt % to 8.0 wt % of total caprylic acid (C8:0) and capric acid (C10:0); and (b) from 55 wt % to 70 wt % of saturated fatty acids (SAFA); and wherein the fat composition has a weight ratio of total lauric acid (C12:0), myristic acid (C14:0) and palmitic acid (C16:0) to saturated fatty acid (SAFA) from 0.80:1 to 0.92:1; and wherein said wt % is relative to the acids bound as acyl groups in glycerides in the fat composition and based on the total weight of C8 to C24 fatty acids; (iii) from 50 wt % to 60 wt % of water relative to the total weight of the product; and (iv) from 12 wt % to 18 wt % of starch and hydrocolloid relative to the total weight of the product.

In another most preferred aspect, the vegan cheese product as disclosed herein comprises (i) from 5 wt % to 8 wt % of a plant-based protein relative to the total weight of the product, wherein from 95 wt % to 100 wt % of the plant-based protein relative to the total weight of the plant-based protein is selected from the group consisting of faba bean protein isolate, mung bean protein isolate and combinations thereof; (ii) from 20 wt % to 25 wt % of a fat composition relative to the total weight of the product, comprising (a) from 6.0 wt % to 8.0 wt % of total caprylic acid (C8:0) and capric acid (C10:0); (b) from 60 wt % to 70 wt % of saturated fatty acids (SAFA); (c) from 25 wt % to 35 wt % of lauric acid (C12:0); (d) from 10 wt % to 15 wt % of myristic acid (C14:0); (e) from 7 wt % to 13 wt % of palmitic acid (C16:0); (f) from 1.5 wt % to 5.0 wt % of stearic acid (C18:0); (g) from 20 wt % to 35 wt % of oleic acid (C18:1); (h) from 2 wt % to 10 wt % of linoleic acid (C18:2); and (i) from 20 wt % to 35 wt % of monounsaturated fatty acids (MUFA); and wherein the fat composition has a weight ratio of total lauric acid (C12:0), myristic acid (C14:0) and palmitic acid (C16:0) to saturated fatty acid (SAFA) from 0.80:1 to 0.90:1; and wherein said wt % is relative to the acids bound as acyl groups in glycerides in the fat composition and based on the total weight of C8 to C24 fatty acids; (iii) from 50 wt % to 60 wt % of water relative to the total weight of the product; and (iv) from 14 wt % to 18 wt % of starch and hydrocolloid relative to the total weight of the product.

In another aspect, the present disclosure is directed to a process for making the vegan cheese product as disclosed in the first aspect, the process comprising the steps of a) heating water to a temperature not exceeding 70° C.; b) adding plant-based protein to the water and mixing to hydrate the protein to provide a hydrated protein solution; c) pre-melting fat composition and adding the melted fat composition to the hydrated protein solution to provide a first mixture; d) mixing the first mixture to form an emulsion; e) adding the other ingredients to the emulsion to make a second mixture; f) homogenizing the second mixture; g) heating the second mixture to a temperature not exceeding 100° C.; and h) cooling the second mixture to form the vegan cheese product.

### Process of Making Vegan Cheese Product

The vegan cheese product according to the present disclosure can be made by a variety of methods. In a preferred aspect, the process for making a vegan cheese product as disclosed herein comprises the steps of a) heating water to a temperature from 43° C. to 65° C.; b) adding plant-based protein to the water and mixing to hydrate the protein to provide a hydrated protein solution; c) pre-melting fat composition and adding the melted fat composition to the hydrated protein solution to provide a first mixture; d) mixing the first mixture to form an emulsion; e) adding the other ingredients to the emulsion to make a second mixture; f) homogenizing the second mixture; g) heating the second mixture to a temperature from 68° C. to 90° C.; and h) cooling the second mixture to form the vegan cheese product.

In a more preferred aspect, the process for making a vegan cheese product as disclosed herein comprises the steps of a) heating water to a temperature from 52° C. to 57° C.; b) adding plant-based protein to the water and mixing to hydrate the protein to provide a hydrated protein solution; c) pre-melting fat composition and adding the melted fat composition to the hydrated protein solution to provide a first mixture; d) mixing the first mixture to form an emulsion; e) adding the other ingredients to the emulsion to make a second mixture; f) homogenizing the second mixture; g) heating the second mixture to a temperature from 77° C. to 85° C.; and h) cooling the second mixture to form the vegan cheese product.

In an even more preferred aspect, the process for making a vegan cheese product as disclosed herein consists of the steps of a) heating water to a temperature from 52° C. to 57° C.; b) adding plant-based protein to the water and mixing to hydrate the protein to provide a hydrated protein solution; c) pre-melting fat composition and adding the melted fat composition to the hydrated protein solution to provide a first mixture; d) mixing the first mixture to form an emulsion; e) adding the other ingredients to the emulsion to make a second mixture; f) homogenizing the second mixture; g) heating the second mixture to a temperature from 77° C. to 85° C.; and h) cooling the second mixture in molds to form the vegan cheese product.

Preferably, after cooling of step h), the vegan cheese product is packaged and stored in the refrigerator for at least 3 to 9 days, such as 5 to 8 days or 7 days before consumption.

In another aspect, any of the process described herein may further comprise cutting the vegan cheese product into various shapes and sizes, such as blocks, slices, cubes, shreds and the like.

### Method of Using Vegan Cheese Product

In a further aspect, the present disclosure is directed to a use of the vegan cheese product as disclosed in the first aspect in a food product. In a further preferred aspect, the present disclosure is directed to a use of the vegan cheese product as disclosed in the first aspect in a bakery product such as pizza or sandwich or as a spreadable product. The vegan cheese product may be cooked and processed using any conventional equipment, including the use of a laydown cooker, kettle, oven or other device. Shredding and packaging may also be accomplished with conventional equipment.

In another aspect, the present disclosure is directed to a food product comprising the vegan cheese product as disclosed herein.

### PARAGRAPHS OF THE INVENTION

Paragraph 1. A vegan cheese product comprising:
water; and
a plant-based protein isolate selected from the group consisting of faba bean protein isolate, mung bean protein isolate, and combinations thereof;
wherein the product comprises at least 2 g of plant-based protein per ounce.

Paragraph 2. The vegan cheese product of paragraph 1, further comprising from about 10% to about 20% starch by weight.

Paragraph 3. The vegan cheese product of paragraph 1, further comprising from about 10% to about 15% solid fat.

Paragraph 4. The vegan cheese product of paragraph 3 wherein the solid fat is selected from the group consisting of palm oil, palm kernel oil, coconut oil, and combinations thereof.

Paragraph 5. The vegan cheese product of paragraph 1, further comprising from about 5% to about 10% liquid oil.

Paragraph 6. The vegan cheese product of paragraph 5, wherein the liquid oil is selected from the group consisting of canola oil, sunflower oil, soybean oil, and combinations thereof.

Paragraph 7. The vegan cheese product of paragraph 1, wherein the product is an oil in water emulsion.

Paragraph 8. The vegan cheese product of paragraph 1, wherein the plant-based protein isolate comprises at least 85% protein on a dry weight basis.

Paragraph 9. The vegan cheese product of paragraph 1, comprising from about 7% to about 20% plant-based protein by weight.

Paragraph 10. A process for preparing a vegan cheese product, the process comprising
mixing plant-based protein isolates with water;
combining solid fat and liquid oil and melting to form a melted fat/oil blend;
adding the melted fat/oil blend to the plant-based protein isolates in water with mixing to form an emulsion; and
heating the emulsion to a temperature of from about 160° F. to about 185° F.;
wherein the product comprises at least 2 g of plant-based protein per ounce.

Paragraph 11. The method of paragraph 10, wherein the plant-based protein isolates are selected from the group consisting of faba bean protein isolate, mung bean protein isolate, and combinations thereof.

### EXAMPLES

The following non-limiting examples illustrate the invention and do not limit its scope in any way, as many variations of the present invention are possible without departing from its spirit or scope. In the examples and throughout this specification, all percentages, parts and ratios are by weight unless indicated otherwise.

### Example 1

This study was conducted using the same base formulation for vegan cheese containing 4 g protein per slice (21 g) (i.e., 19% protein). The base formulation was altered to test 3 different fats in combination with 3 different protein blends, for a total of 9 combinations. Canola protein isolate Puratein® C commercially available from Merit Functional Foods was used in each sample composition along with faba bean protein isolate, pea protein isolate, or soy protein isolate, all commercially available from Bunge (Chesterfield, MO). The three fat compositions used were Vream® 217, SansTrans® HF, and Freedom® 960, all commercially available from Bunge (Chesterfield, MO). The formulations for the products tested are set forth in Table 1 below. Samples 2, 5 and 8 are examples of inventive compositions comprising faba bean protein isolate according to the present disclosure. In parallel, comparative Samples 1, 3, 4, 6 and 7 were prepared with soy protein isolate or pea protein isolate.

TABLE 1
Vegan Cheese Compositions

| | Vegan Cheese Composition (wt %)¹ | | | | | | | |
|---|---|---|---|---|---|---|---|---|
| | Samples | | | | | | | |
| Ingredients | 1 | 2 | 3 | 4 | 5 | 6 | 7 | 8 |
| Soy Protein | 13.70 | 0 | 0 | 13.70 | 0 | 0 | 13.70 | 0 |
| Isolate | | | | | | | | |
| Faba bean | 0 | 13.70 | 0 | 0.00 | 13.70 | 0 | 0 | 13.70 |
| Protein | | | | | | | | |
| Isolate | | | | | | | | |
| Pea Protein | 0 | 0 | 13.70 | 0 | 0 | 13.70 | 0 | 0 |
| Isolate | | | | | | | | |
| Canola | 5.91 | 5.91 | 5.91 | 5.91 | 5.91 | 5.91 | 5.91 | 5.91 |
| Protein | | | | | | | | |
| Isolate | | | | | | | | |
| (Puratein ® | | | | | | | | |
| C) | | | | | | | | |
| Water | 56.34 | 56.34 | 56.34 | 56.34 | 56.34 | 56.34 | 56.34 | 56.34 |
| Food Grade | 1.20 | 1.20 | 1.20 | 1.20 | 1.20 | 1.20 | 1.20 | 1.20 |
| Salt | | | | | | | | |
| Kappa | 0.85 | 0.85 | 0.85 | 0.85 | 0.85 | 0.85 | 0.85 | 0.85 |
| Carageenan | | | | | | | | |
| (from | | | | | | | | |
| Ingredients | | | | | | | | |
| Solutions, | | | | | | | | |
| Inc.) | | | | | | | | |
| VREAM ® | 22.00 | 22.00 | 22.00 | 0 | 0 | 0 | 0 | 0 |
| 217 | | | | | | | | |
| SansTrans ® | 0 | 0 | 0 | 0 | 0 | 0 | 22.00 | 22.00 |
| HF | | | | | | | | |
| Freedom ® | 0 | 0 | 0 | 22.00 | 22.00 | 22.00 | 0 | 0 |
| 960 | | | | | | | | |
| Totals | 100 | 100 | 100 | 100 | 100 | 100 | 100 | 100 |

¹Wt % is relative to the total weight of the composition.

The analytical data of the 3 fat compositions used for the vegan cheese is shown in Table 2 below.

TABLE 2
Analytical Results of Vream ® 217, SansTrans ® HF
and Freedom ® 960.

| | Vream ® 217 | SansTrans ® HF | Freedom ® 960 |
|---|---|---|---|
| C8:0 | 0.0 | 0.0 | 0.1 |
| C10:0 | 0.0 | 0.2 | 2.8 |
| C12:0 | 0.0 | 4.2 | 51.3 |
| C14:0 | 0.1 | 2.5 | 19.9 |
| C16:0 | 10.7 | 37.7 | 9.2 |
| C17:0 | 0.30 | 0.1 | 0.0 |
| C18:0 | 33.0 | 4.2 | 2.2 |
| C18:1 | 16.8 | 39.6 | 10.3 |
| C18:2 | 33.1 | 1.0 | 1.6 |
| C18:3 | 4.5 | 0.3 | 0.0 |
| C20:0 | 0.4 | 0.4 | 0.1 |
| C20:1 | 0.1 | 0.1 | 0.1 |
| C22:0 | 0.4 | 0.1 | 0.0 |
| C22:1 | 0.0 | 0.0 | 0.0 |
| C24:0 | 0.1 | 0.1 | 0.0 |
| SAFA | 45.1 | 49.5 | 87.9 |
| MUFA | 17.0 | 39.9 | 10.4 |
| PUFA | 37.6 | 10.2 | 1.6 |
| TRANS | 0.4 | 0.5 | 0.1 |
| C8:0 + C10:0 | 0.0 | 0.2 | 2.9 |
| (C12:0 + C14:0 + | 0.24:1 | 0.90:1 | 0.91:1 |
| C16:0)/SAFA | | | |
| US-N10 | 30 | 51 | 80 |
| US-N20 | 25 | 29 | 68 |
| US-N25 | 18 | 20 | 48 |
| US-N30 | 12 | 13 | 8 |
| US-N35 | 9 | 7 | 1 |

In the above table:
Cx:y refers to a fatty acid having x carbon atoms and y double bonds; levels were determined by GC-FAME (ISO 12966-2: 2014 and ISO 12966-4: 2015);
SAFA refers to saturated fatty acids;
MUFA refers to mono-unsaturated fatty acid;
PUFA refers to poly-unsaturated fatty acid;
TRANS refers to trans fatty acids: unsaturated fatty acids having a double bond in a trans arrangement; and
US-Nx refers to solid fat content determined by NMR on unstabilized fat measured at x° C. according to ISO 8292-1: 2008.

All of the samples were prepared by admixture of the ingredients in the proportions indicated to water and then heated in a Thermomix to 130° F. (about 54° C.) according to the following order. The proteins were added to the water and allowed to hydrate at mixing speed 3 for 5 mins. Separately, the oil/fat were combined and heated in a microwave oven until completely melted. With continuous mixing at speed 3, the melted oil/fat was added and the resultant mixture was allowed to blend for 2 mins. After 2 mins, the remaining ingredients were added. The samples were mixed at speed 4 and heated to 160° F. (about 71° C.). Once the temperature was reached, the samples were mixed for an additional 2 mins and then quickly poured into parchment lined molds and allowed to cool on a cooling rack. After 30 mins of cooling, the samples were transferred to a refrigerator at 40° F. (about 4° C.). After 24 hours, the samples were extracted from their molds and vacuum sealed for analysis after 1 week and then resealed for an additional analysis after 2 weeks.

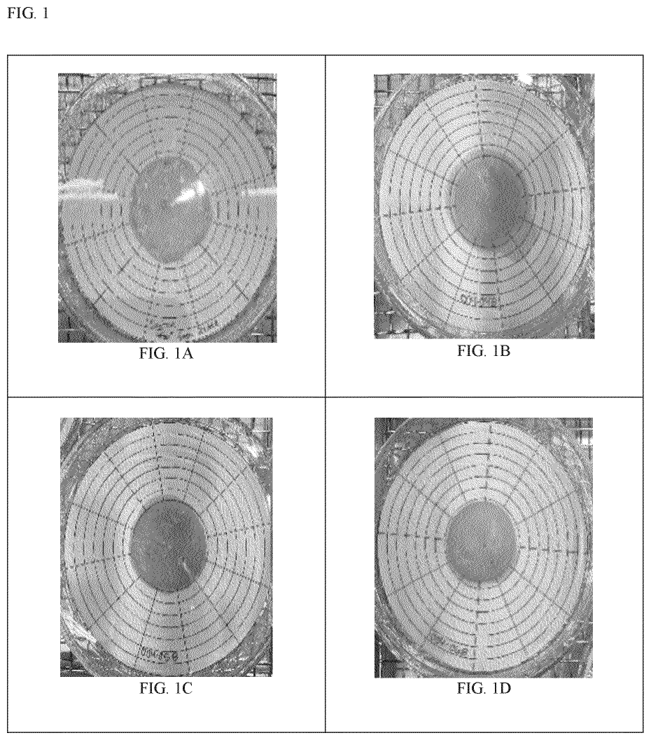

The meltability of the vegan cheese samples were measured by the Schreiber Melt Test (Kosikowski, Cheese and Fermented Milk Foods, 2nd ed., p. 337-340, 1977). The Schreiber Test was performed by cutting a piece of the vegan cheese sample having a height of 4 mm and a diameter of 40 mm. The cheese round was placed in the center on a concentric circle graph paper inside a large glass petri dish. The dishes were placed directly on the racks of an oven preheated to 450° F. (about 232° C.) for 5 mins. Once the 5 mins had elapsed, the petri dishes were removed from the oven. Photos were taken of the samples and a measurement along the longest flow line from the center to the edge of the melt was made as an indication cheese meltability. The diameter of each cheese round was measured 3 times to get an average. The starting 40 mm was subtracted from the final melted diameter average to score the samples. The results are shown in FIG. 1.

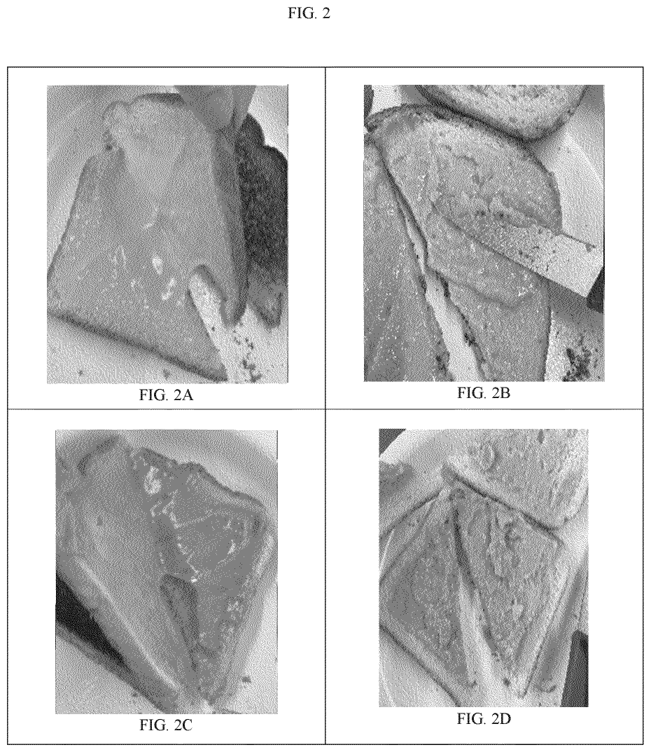

A grilled cheese application test (“Grilled Cheese Test”) was conducted on each of the vegan cheese sample as well as a control dairy-based cheese. For the Grilled Cheese Test, two slices of white bread (sara lee brand) were used, and 5 g of butter was spread evenly on each side of the bread. Then two 21 g slices of vegan cheese were added to the bread, totaling 42 grams of cheese. The sandwich with butter side up and down was placed on a preheated pan over medium heat (330-400° F. (about 165-204° C.)) and cooked for 3 mins on each side. Once cooking was completed the sandwich was removed, immediately sliced diagonally and observationally analyzed. The results are shown in FIG. 2.

The herein disclosed inventive vegan cheese compositions according to the present disclosure (Samples 2, 5 and 8) have superior melt as compared to the comparative compositions made with other proteins (Samples 1, 3, 4, 6 and 7) as demonstrated by the results of the Schreiber Melt test. The inventive vegan cheese samples made with faba bean protein isolate and canola protein isolate blends (Samples 2, 5 and 8) melted 10 mm which was an improvement over the comparative samples made with pea protein isolate/canola protein isolate—Samples 3 and 6 (having 6 mm melt) as well as the comparative samples made with soy protein isolate/canola protein isolate blends—Samples 1, 4 and 7 (having 3 mm melt). The dairy based cheese slice melted an average of 13 mm melt.

In the Grilled Cheese Test, the inventive vegan cheese compositions with faba bean and canola protein isolates (Samples 2, 5 and 8) have superior texture and/or melt properties as compared to the comparative compositions with protein blends prepared with soy/canola proteins (Samples 1, 4 and 7) and pea/canola proteins (Samples 3 and 6). The faba bean protein isolate containing samples (Samples 2, 5 and 8) have a gooey texture and appearance which sticks to the bread and itself providing a bit of stretchy appearance desired when pulling apart on a grilled cheese sandwich. The faba bean protein/canola protein samples (Samples 2, 5 and 8) were also the only samples that have a shiny/glossy appearance while other samples were dull. In the Grilled Cheese Test, the soy protein containing samples (Samples 1, 4 and 7) had a jelly like spreadable texture and only somewhat melted. The pea protein containing samples (Samples 3 and 6) have large amounts of visually not melted cheese slices which stuck to each other or fell off when pulled apart, the appearance was also closer to a spread and not fully melted.

The herein disclosed inventive vegan cheese compositions behave like dairy-based cheese in many ways. Without wishing to be bound by theory, it is believed that the desirable dairy-based cheese like properties are achieved through the reduction of starch and the replacement with certain plant proteins that allow the plant based cheese to be firm enough to slice and shred, yet still pliable similar to a dairy single cheese slice. As demonstrated by the results, the product melts very well and has improved melt over other type of plant proteins. The product contains ≥2 g plant protein per ounce whereas many known comparative products have 0 g.

In Samples 2, 5 and 8 the percentage of faba protein isolate by weight based on the total weight of protein (thus including canola protein as well) is 69.86%.

The inventive vegan cheese composition made by SansTrans® HF (Sample 8) had the outstanding and desirable meltability and stretchability properties compared to other samples. The inventive vegan cheese composition made by Freedom® 960 (Sample 5) also had acceptable texture and consistency. However, the inventive vegan cheese composition made by Vream® 217 (Sample 2) had undesired and poor organoleptic properties such as waxiness and flavor intensity as compared to Sample 5 or Sample 8.

### Example 2

A fat composition (Fat A) was firstly prepared by blending 65% by weight of refined coconut oil and 35% by weight of canola oil (rapeseed oil). The analytical results of Fat A are shown in Table 3.

TABLE 3
Analytical results of refined coconut
oil, canola oil (rapeseed oil) and Fat

| | Coconut oil | Canola oil | Fat A |
|---|---|---|---|
| C8:0 | 5.7 | 0.0 | 3.7 |
| C10:0 | 5.1 | 0.0 | 3.3 |
| C12:0 | 44.8 | 0.0 | 29.1 |
| C14:0 | 19.0 | 0.1 | 12.4 |
| C16:0 | 11.6 | 4.1 | 9.0 |
| C16:1 | 0.0 | 0.0 | 0.0 |
| C17:0 | 0.0 | 0.0 | 0.0 |
| C18:0 | 3.1 | 1.9 | 2.7 |
| C18:1 | 8.1 | 60.1 | 26.3 |
| C18:2 | 2.0 | 21.2 | 8.7 |
| C18:3 | 0.0 | 9.3 | 3.3 |
| C20:0 | 0.1 | 0.6 | 0.3 |
| C20:1 | 0.1 | 1.5 | 0.6 |
| C22:0 | 0.0 | 0.5 | 0.2 |
| C22:1 | 0.0 | 0.0 | 0.0 |
| C24:0 | 0.0 | 0.0 | 0.0 |
| SAFA | 89.8 | 7.3 | 61.0 |
| MUFA | 8.1 | 62.0 | 27.0 |
| PUFA | 2.0 | 30.7 | 12.0 |
| TRANS | 0.1 | 1.0 | 0.4 |
| C8:0 + C10:0 | 10.8 | 0.0 | 7.0 |
| (C12:0 + C14:0 + | 0.84:1 | 0.58:1 | 0.83:1 |
| C16:0)/SAFA | | | |
| US-N10 | 80 | 0 | 42 |
| US-N20 | 35 | 0 | 9 |
| US-N25 | 5 | 0 | 0 |
| US-N30 | 0 | 0 | 0 |
| US-N35 | 0 | 0 | 0 |

In the above table:
Cx:y refers to a fatty acid having x carbon atoms and y double bonds; levels determined by GC-FAME (ISO 12966-2: 2014 and ISO 12966-4: 2015);
SAFA refers to saturated fatty acids;
MUFA refers to mono-unsaturated fatty acid;
PUFA refers to poly-unsaturated fatty acid;
TRANS refers to trans fatty acids: unsaturated fatty acids having a double bond in a trans arrangement;
US-Nx refers to solid fat content determined by NMR on unstabilized fat measured at x° C. according to ISO 8292-1: 2008.

The inventive vegan cheese composition comprising faba bean protein isolate according to the present disclosure is shown in Table 4 below.

TABLE 4
Vegan Cheese Composition

| Ingredients | Weight (wt %)¹ |
|---|---|
| Faba bean protein isolate² | 6.46 |
| Water | 50.35 |
| Fat A | 23.00 |
| Kappa Carrageenan | 0.75 |
| (from Ingredients | |
| Solutions, Inc.) | |
| Starch and hydrocolloid blend | 16.00 |
| (commercially available product - | |
| Ticagel ® CA 0979M) | |
| Vegan lactic acid | 0.13 |
| Salt | 1.30 |
| Xanthan Gum | 0.20 |
| Cheddar cheese flavor | 1.60 |
| Butter flavor | 0.03 |
| Colorant | 0.08 |
| Sorbic acid | 0.10 |
| Total | 100.00 |

¹Wt % is relative to the total weight of the composition.
²Faba bean protein isolate is in form of powder and the percentage of dry matter in faba bean protein isolate is from 88% to 90%.

18 Kg vegan cheddar cheese blocks were produced. The ingredients were weighted according to the formulation indicated in Table 4. The dry ingredients, except the faba bean protein isolate, were preblended. Water was then added to the preblended dry ingredients in the thermomixer, mixed at mixing speed 3 and heated to 130° F. (about 54° C.). During the mixing, faba bean protein isolate was then slowly added to the thermomixer and continuously mixed for 5 mins before stopping to scrape down. After the protein was hydrated, the mixing was restarted and continued. The pre-melted Fat A was then added and mixed for 2 mins to emulsify. The starch and hydrocolloid blend were slowly added and mixed in the thermomixer in order to allow the hydration which took approximatively 5 mins. The remaining ingredients vegan lactic acid, colorant and flavors were then added. The mixing speed was slightly increased, and the mixing was continued for 5 mins before stopping to scrape. The mixture in the thermomixer was then heated to 185° F. (about 85° C.). Once this temperature was reached, the heating was turned off and the mixing was kept for 2 mins. The mixture was poured out of the thermomixer into molds and the product was cooled on rack for 30 mins priors to refrigeration.

Based on the results (data not shown), the obtained product had a very similar appearance, texture and organoleptic properties as the commercial dairy cheddar cheese.

### Example 3

A fat composition (Fat B) was firstly prepared by blending 70% by weight of refined coconut oil and 30% by weight of high oleic sunflower oil (HOSO). The analytical results of Fat B are shown in Table 5.

TABLE 5
Analytical results of refined coconut oil and Fat B

| | | High oleic | |
|---|---|---|---|
| | Coconut | sunflower oil | Fat |
| | oil | (HOSO) | B |
| C8:0 | 5.7 | 0.0 | 4.0 |
| C10:0 | 5.1 | 0.0 | 3.6 |
| C12:0 | 44.8 | 0.0 | 31.3 |
| C14:0 | 19.0 | 0.0 | 13.3 |
| C16:0 | 11.6 | 3.7 | 9.3 |
| C16:1 | 0.0 | 0.0 | 0.0 |
| C17:0 | 0.0 | 0.0 | 0.0 |
| C18:0 | 3.1 | 5.4 | 3.8 |
| C18:1 | 8.1 | 81.3 | 30.0 |
| C18:2 | 2.0 | 9.0 | 4.1 |
| C18:3 | 0.0 | 0.0 | 0.0 |
| C20:0 | 0.1 | 0.4 | 0.2 |
| C20:1 | 0.1 | 0.1 | 0.1 |
| C22:0 | 0.0 | 0.0 | 0.0 |
| C22:1 | 0.0 | 0.0 | 0.0 |
| C24:0 | 0.0 | 0.0 | 0.0 |
| SAFA | 89.8 | 9.5 | 65.7 |
| MUFA | 8.1 | 81.5 | 30.1 |
| PUFA | 2.0 | 9.0 | 4.1 |
| TRANS | 0.1 | 1.0 | 0.3 |
| C8:0 + C10:0 | 10.8 | 0.0 | 7.6 |
| (C12:0 + C14:0 + | 0.84:1 | 0.39:1 | 0.82:1 |
| C16:0)/SAFA | | | |
| US-N10 | 80 | 0 | 44 |
| US-N20 | 35 | 0 | 10 |
| US-N25 | 5 | 0 | 0 |
| US-N30 | 0 | 0 | 0 |
| US-N35 | 0 | 0 | 0 |

In the above table:
Cx:y refers to a fatty acid having x carbon atoms and y double bonds; levels determined by GC-FAME (ISO 12966-2: 2014 and ISO 12966-4: 2015);
SAFA refers to saturated fatty acids;
MUFA refers to mono-unsaturated fatty acid;
PUFA refers to poly-unsaturated fatty acid;
TRANS refers to trans fatty acids: unsaturated fatty acids having a double bond in a trans arrangement;
US-Nx refers to solid fat content determined by NMR on unstabilized fat measured at x° C. according to ISO 8292-1: 2008.

The inventive vegan mozzarella cheese product according to the present disclosure is shown in Table 6 below.

TABLE 6
Vegan Mozzarella Cheese Product

| Ingredients | Weight Percentage (wt %)¹ |
|---|---|
| Protein isolate² | 6.50 |
| Water | 51.22 |
| Fat B | 23.00 |
| Kappa Carrageenan | 0.75 |
| (from Ingredients | |
| Solutions, Inc.) | |
| Starch and hydrocolloid blend | 16.00 |
| (commercially available product - | |
| Ticagel ® CA 0979M) | |
| Vegan lactic acid | 0.15 |
| Salt | 1.25 |
| Xanthan Gum | 0.20 |
| Mozzarella type flavor emulsion | 0.80 |
| Butter flavor | 0.03 |
| Sorbic acid | 0.10 |
| Total | 100.00 |

¹Wt % is relative to the total weight of the composition.
²Protein isolate selected from faba bean protein isolate, mung bean protein isolate or canola protein isolate.

Three types of protein isolates (e.g., faba bean protein isolate, mung bean protein isolate and canola protein isolate) were selected to be used respectively in order to produce the vegan mozzarella cheese products according to the formulation in Table 6. The vegan mozzarella cheese products are listed in Table 7 with the corresponding protein isolates.

### Table 7—Overview of Vegan Mozzarella Cheese Products

TABLE 7
Overview of vegan Mozzarella cheese products

| | Product 1 | Product 2 | Product 3 |
|---|---|---|---|
| Protein | Faba bean protein | Mung bean protein | Canola protein |
| isolate | isolate | isolate | isolate |

The ingredients were weighed according to the formulation indicated in Table 6. The dry ingredients, except the protein isolate, were preblended. Water was then added to the preblended dry ingredients in the thermomixer, mixed at mixing speed 3 and heated to 130° F. (about 54° C.). During the mixing, the protein isolate was then slowly added to the thermomixer and continuously mixed for 5 mins before stopping to scrape down. After the protein was hydrated, the mixing was restarted and continued. The pre-melted Fat B was then added and mixed for 2 mins to emulsify. The mixture in the thermomixer was heated up to 160° F. (about 71° C.). The starch and hydrocolloid blend was slowly added and mixed in the thermomixer for approximately 5 mins in order to allow for the hydration. The remaining ingredients (vegan lactic acid, colorant and flavors) were then added. The mixing speed was slightly increased and the mixing continued for 5 mins before stopping to scrape. The mixture in the thermomixer was then heated to 185° F. (about 85° C.). Once this temperature was reached, the heating was turned off and the mixing was kept for 2 mins. The mixture was poured out of the thermomixer into molds lined with parchment paper. After 24 hours, the products were removed from the molds and vacuum sealed. After 2 weeks, the products were removed and sliced, shredded and cut as needed for testing and the remaining cheese products were vacuum sealed and testing repeated after 4 weeks.

The meltability of the cheese products were assessed by the Schreiber Melt Test, as described in Example 1. The Schreiber Melt Test was performed by cutting a piece of cheese product having a height of 4 mm and a diameter of 40 mm. The cheese round was placed on a graph paper inside a glass petri dish. The dishes were placed on the racks of an oven preheated to 450° F. (about 232° C.) for 5 mins. Once the 5 mins had elapsed, the petri dishes were removed from the oven. The melted cheese product is cooled and photos were taken of the samples. Measurements along the longest flow line from the center to the edge of the melt was made as an indication cheese meltability. The diameter of each cheese round was measured 3 times to get an average. The starting 40 mm was subtracted from the final melted diameter average to score the samples.

Based on the results, it was observed that Product 2 with mung bean protein isolate had the highest melt distance (10 mm) amongst all the products which shows a desirable melting property. Product 1 with faba bean protein isolate had a medium melt distance (3 to 4 mm) showing an acceptable melting property while Product 3 with Canola protein isolate did not melt at all (0 mm) which would not be desired as a vegan cheese product.

The Grilled Cheese Test, as described in Example 1, was conducted on the cheese products. For the Grilled Cheese Test, two slices of bread (sara lee brand) were used, and 5 grams of butter was put on one side of the two slices of bread. 42 grams of cheese products were placed between the two slices of bread. The bread with cheese was then placed on medium heat pan (350° F.-450° F. (about 177-232° C.)) with buttered side facing up and down. Each side was heated for 3 mins. Once cooking was completed, the sandwich was removed, immediately sliced diagonally and observationally analyzed (i.e., diagonal halves were separated to determine melt).

Based on the results (data not shown), it was observed that Product 1 with the faba bean protein isolate and Product 2 with the mung bean protein isolate have full melting and stretchy elastic appearance. The bread in these products was intact and the cheese layer was gooey and had a desirable consistency. However, in Product 3 with the canola protein isolate, the cheese layer had pulled away from the bread and did not melt completely.

The listing or discussion of an apparently prior-published document in this specification should not necessarily be taken as an acknowledgement that the document is part of the state of the art or is common general knowledge.

Preferences and options for a given aspect, embodiment, feature or parameter of the invention should, unless the context indicates otherwise, be regarded as having been disclosed in combination with any and all preferences and options for all other aspects, embodiments, features and parameters of the invention.

As will be understood by one skilled in the art, for any and all purposes, particularly in terms of providing a written description, all ranges disclosed herein also encompass any and all possible subranges and combinations of subranges thereof. Any listed ranges can be easily recognized as sufficiently describing and enabling the same range being broken down into at least equal halves, thirds, quarters, fifths, tenths, etc. As will also be understood by one skilled in the art all language such as “up to”, “at least”, “greater than”, “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

1. A vegan cheese product comprising:
(i) a plant-based protein, wherein at least 35 wt % of the plant-based protein is selected from the group consisting of faba bean protein, mung bean protein and combinations thereof, and wherein the wt % is relative to the total weight of the plant-based protein;
(ii) a fat composition comprising:
(a) at most 9 wt % of total caprylic acid (C8:0) and capric acid (C10:0); and
(b) from 20 wt % to 88 wt % of saturated fatty acids (SAFA); and
wherein the fat composition has a weight ratio of total lauric acid (C12:0), myristic acid (C14:0) and palmitic acid (C16:0) to saturated fatty acid (SAFA) from 0.50:1 to 0.95:1; and
wherein said wt % is relative to the acids bound as acyl groups in glycerides in the fat composition and based on the total weight of C8 to C24 fatty acids; and
(iii) water.

2. The vegan cheese product according to claim 1, comprising from 2 wt % to 20 wt % of the plant-based protein, relative to the total weight of the product.

3. The vegan cheese product according to claim 1, comprising from 30 wt % to 80 wt % of the water, relative to the total weight of the product.

4. The vegan cheese product according to claim 1, wherein the plant-based protein comprises at least 55 wt % the plant-based protein selected from the group consisting of faba bean protein, mung bean protein and combinations thereof, wherein the wt % is relative to the total weight of the plant-based protein.

5. The vegan cheese product according to claim 1, wherein the plant-based protein comprises faba bean protein, preferably a faba bean protein isolate.

6. The vegan cheese product according to claim 5, wherein the faba bean protein isolate has a protein content of at least 80 wt % on dry matter.

7. The vegan cheese product according to claim 1, comprising from 10 wt % to 35 wt % of the fat composition relative to the total weight of the product.

8. The vegan cheese product according to claim 1, wherein the fat composition comprises:
at most 8.5 wt % of total caprylic acid (C8:0) and capric acid (C10:0); and/or
from 3 wt % to 60 wt % of lauric acid (C12:0); and/or
from 1 wt % to 25 wt % of myristic acid (C14:0); and/or
from 5 wt % to 45 wt % of palmitic acid (C16:0); and/or
from 1 wt % to 15 wt % of stearic acid (C18:0); and/or
from 9 wt % to 45 wt % of oleic acid (C18:1); and/or
from 0.5 wt % to 15 wt % of linoleic acid (C18:2); and/or
from 10 wt % to 50 wt % of monounsaturated fatty acids (MUFA); and/or
at most 15 wt % of polyunsaturated fatty acids (PUFA);
wherein said wt % is relative to the acids bound as acyl groups in glycerides in the fat composition and based on the total weight of C8 to C24 fatty acids.

9. The vegan cheese product according to claim 1, wherein the fat composition comprises from 30 wt % to 88 wt % of the saturated fatty acids (SAFA), wherein said wt % is relative to the acids bound as acyl groups in glycerides in the fat composition and based on the total weight of C8 to C24 fatty acids.

10. The vegan cheese product according to claim 1, wherein the fat composition has a weight ratio of total lauric acid (C12:0), myristic acid (C14:0) and palmitic acid (C16:0) to saturated fatty acid (SAFA) from 0.70:1 to 0.95:1.

11. The vegan cheese product according to claim 1, wherein the fat composition has:
from 35 to 85 solid fat content at 10° C.; and/or
from 5 to 75 solid fat content at 20° C.; and/or
at most 55 solid fat content at 25° C.; and/or
at most 20 solid fat content at 30° C.; and/or
at most 15 solid fat content at 35° C.;
wherein the solid fat content is measured on unstabilized fat according to ISO 8292-1:2008.

12. The vegan cheese product according to claim 1, further comprising:
(iv) at most 25 wt % of starch and hydrocolloid, wherein wt % is relative to the total weight of the vegan cheese product; and/or
(v) one or more ingredients selected from the group consisting of flavor, colorant, salt, kappa carrageenan, lactic acid, xanthan gum and sorbic acid.

13. The vegan cheese product according to claim 1, wherein the vegan cheese product is free or substantially free of a protease enzyme.

14. The vegan cheese product according to claim 1, wherein the vegan cheese product has a melt test distance of at least 3 mm, from center to melt edge according to the Schreiber Melt Test as disclosed herein.

15. Process for making a vegan cheese product according to claim 1, the process comprising the steps of:
a) heating water to a temperature not exceeding 70° C.;
b) adding plant-based protein to the water and mixing to hydrate the protein to provide a hydrated protein solution;
c) pre-melting fat composition and adding the melted fat composition to the hydrated protein solution to provide a first mixture;
d) mixing the first mixture to form an emulsion;
e) adding the other ingredients to the emulsion to make a second mixture;
f) homogenizing the second mixture;
g) heating the second mixture to a temperature not exceeding 100° C.; and
h) cooling the second mixture to form the vegan cheese product.

16. Use of a vegan cheese product according to claim 1 in a food product.

17. A food product comprising a vegan cheese product according to claim 1.
